(19) United States
(12) Patent Application Publication
(10) Pub. No.: US 2018/0284570 A1
(43) Pub. Date: Oct. 4, 2018

(54) OPTICAL UNIT WITH SHAKE CORRECTION FUNCTION AND METHOD FOR MANUFACTURING OPTICAL UNIT WITH SHAKE CORRECTION FUNCTION

(71) Applicant: NIDEC SANKYO CORPORATION, Suwa-gun Nagano (JP)

(72) Inventors: Shinji MINAMISAWA, Suwa-gun Nagano (JP); Toshiyuki WATANABE, Suwa-gun Nagano (JP)

(21) Appl. No.: 15/941,396

(22) Filed: Mar. 30, 2018

(30) Foreign Application Priority Data
Mar. 30, 2017 (JP) 2017-066745

(51) Int. Cl. G03B 5/06; H04N 5/225; H04N 5/232

(52) U.S. Cl. CPC G03B 5/06; H04N 5/2254; G03B 2205/0023; G03B 2205/0069; H04N 5/23287

(57) ABSTRACT

An optical unit may include a movable member include a camera module comprising an optical element and an image pickup element positioned on an optical axis of the optical element; and a camera module holder comprising a cylindrical holding part to hold the camera module from an outside; a swingable supporting mechanism to swingably support the movable member between a reference position and a tilt position; and a supporting member to support the holding part via the swingable supporting mechanism. When the movable member is set in the reference position, seen from an object side in a direction of the axis, the holding part may include a visible portion configured to enable a visual check without an occurrence of an overlap with respect to the camera module, the swingable supporting mechanism, and the supporting member.

### CROSS REFERENCE TO RELATED APPLICATION

The present application claims priority under 35 U.S.C. § 119 to Japanese Application No. 2017-066745 filed Mar. 30, 2017, the entire content of which is incorporated herein by reference.

### BACKGROUND

### Field of the Invention

At least an embodiment of the present invention relates to an optical unit with shake correction function that is incorporated in a handheld terminal or a mobile object and a method for manufacturing the optical unit with shake correction function.

### Description of the Related Documents

An image pickup apparatus incorporated in a mobile object such as a vehicle or an unmanned helicopter is provided with an optical unit having mounted an optical element for imaging thereon. The optical unit of such a type is required to restrict disturbance of a picked up image exerted by vibration of the image pickup apparatus. Therefore, as the optical unit, there has been proposed an optical unit with shake correction function configured to swing a movable object provided with an optical element in a pitching (vertical swing, tilting) direction and a yawing (transverse swing, panning) direction that is orthogonal to an optical axis.

An optical unit with shake correction function described in Japanese Unexamined Patent Application Publication No. 2016-61956 is provided with: a movable member provided with an optical element; a swingable supporting mechanism configured to swingably support the movable member; a supporting member configured to support a camera module via the swingable supporting mechanism; and a magnetic driving mechanism for swing configured to swing the camera module. The movable member is provided with: the camera module having an optical element and an image pickup element that is positioned on an optical axis of the optical element; and a camera module holder configured to hold the camera module. The camera module holder is provided with a cylindrical holding part configured to hold the camera module from the outside in a radial direction that is orthogonal to the optical axis. The swingable supporting mechanism is configured to swingably support the camera module holder.

At the time of assembling the optical unit with shake correction function described in Japanese Unexamined Patent Application Publication No. 2016-61956, in order to avoid adhering of a foreign object such as dust to the optical element, it is desirable to carry out the step of causing the camera module holder to hold the camera module to thereby complete the movable member later than the step of causing the supporting member to support the camera module holder via the swingable supporting mechanism, However, if the camera module holder is caused to hold the camera module after the supporting member has been caused to support the camera module holder via the swingable supporting mechanism, the camera module holder is not securely fixed (the camera module holder is swingable relative to the supporting member), and therefore there is a problem that workability is low with respect to the attaching work of attaching the camera module by inserting it into a holding part of the camera module holder.

At least an embodiment of the present invention has been made in view of the problem described above, and at least an embodiment of the present invention provides an optical unit with shake correction function that is capable of causing a swingable camera module holder to easily hold a camera module.

### SUMMARY

In order to solve the problem described above, at least an embodiment of the present invention takes technical means as summarized below. In other words, according to at least an embodiment of the present invention, there is provided an optical unit with shake correction function including: a movable member comprising: a camera module having an optical element and an image pickup element that is positioned on an optical axis of the optical element; and a camera module holder having a cylindrical holding part configured to hold the camera module from an outside in a radial direction that is orthogonal to the optical axis; a swingable supporting mechanism configured to swingably support the movable member between a reference position in which a predetermined axis and an optical axis of the optical element are coincident with each other and a tilt position in which the optical axis tilts relative to the axis; and a supporting member configured to support the holding part via the swingable supporting mechanism, wherein when the movable member is set in the reference position, in a case where the movable member, the swingable supporting mechanism, and the supporting member are seen from an object side in a direction of the axis, the holding part comprises a visible portion configured to enable a visual check without an occurrence of an overlap with respect to the camera module, the swingable supporting mechanism, and the supporting member.

In addition, according to at least an embodiment of the present invention, there is provided a method for manufacturing the optical unit including: a movable member comprising: a camera module having an optical element and an image pickup element that is positioned on an optical axis of the optical element; and a camera module holder having a cylindrical holding part configured to hold the camera module from an outside in a radial direction that is orthogonal to the optical axis; a swingable supporting mechanism configured to swingably support the movable member between a reference position in which a predetermined axis and an optical axis of the optical element are coincident with each other and a tilt position in which the optical axis tilts relative to the axis; and a supporting member configured to support the holding part via the swingable supporting mechanism, wherein when the movable member is set in the reference position, in a case where the movable member, the swingable supporting mechanism, and the supporting member are seen from an object side in a direction of the axis, the holding part comprises a visible portion configured to enable a visual check without an occurrence of an overlap with respect to the camera module, the swingable supporting mechanism, and the supporting member. the method including: causing the camera module holder to support the supporting member via the swingable supporting mechanism; causing a jig to abut against the visible portion in the direction of the axis to thereby swingably support the camera module holder; and inserting the camera module into the holding part from an opposite side to the jig to thereby hold the camera module by the camera module holder.

According to at least an embodiment of the present invention, the holding part of the camera module holder configured to hold the camera module from the outer circumferential side in the movable member is provided with the visible portion configured to enable a visual check without an occurrence of an overlap with respect to the camera module, the swingable supporting mechanism, and the supporting mechanism when seen from the object side. Therefore, in order to avoid adhering of a foreign object such as dust to the optical element, when the step of causing the camera module holder to hold the camera module to thereby complete the movable member is carried out later than the step of supporting the camera module holder by the supporting member via the swingable supporting mechanism, the jig is caused to abut against the visible portion from the object side, and by way of the jig, the camera module holder can be supported so as to disable swinging. In this manner, the camera module can be easily inserted into the holding part to thereby make it easy to carry out the attachment work of causing the camera module holder to hold the camera module. Here, a side on which the optical element is positioned in the direction of the axis is the object side, and a side on which the image pickup element is positioned is the counter-object side.

According to at least an embodiment of the present invention, the holding part is provided with a projection part that projects to the object side, and the visible portion can be employed as a tip end part of the projection part. The tip end part of the projection part provided in the holding part is employed as the visible portion, and the location in the direction of the axis of the visible portion (the portion supported by the jig from the object side) can be easily determined as a desired location.

According to at least an embodiment of the present invention, it is desirable that the swingable supporting mechanism be provided with a plate spring that is overhung between the holding part and the supporting member; the holding part be provided with a movable member side spring fixing part to which the plate spring is to be fixed; the movable member side plate spring fixing part be positioned on the outer circumferential side of the projection part; and the movable member side plate spring fixing part and the projection part be spaced from each other in the radial direction. Thus, in a case where an adhesive agent is applied to the movable member side spring fixing part in order to fix the plate spring as such, it may be possible to prevent the adhesive agent from adhering to the visible portion (the portion supported by the jig from the object side). In addition, the movable member side spring fixing part and the projection part are spaced from each other to be thereby able to avoid contact or interference between the plate spring that is fixed to the movable member side spring fixing part and the jig and thus the plate spring is not deformed.

According at least an embodiment of the present invention, it is desirable that the projection part project from an end portion on an inner circumferential side of the holding part. Thus, the movable member side plate spring fixing part is easily provided on the outer circumferential side of the holding part.

According to at least an embodiment of the present invention, it is desirable that the tip end part of the projection part be positioned on the object side more significantly than the movable member side plate spring fixing part in the direction of the axis. Thus, in a case where an adhesive agent is applied to the movable member side plate spring fixing part in order to fix the plate spring as such, it may be possible to prevent the adhesive agent from adhering to the visible portion (the portion supported by the jig from the object side). In addition, in this manner, it may avoid contact or interference between the plate spring that is fixed to the movable member side plate spring fixing part and the jig and thus the plate spring is not deformed.

According to at least an embodiment of the present invention, it is desirable that the holding part be provided with: plate spring bonding projection parts, each of which projects to the object side, on the inner circumferential side of the movable member side plate spring fixing part; a tip end of the projection part be positioned on the object side more significantly than a tip end of each of the plate spring bonding projection parts; an area in a case where the tip end part of the visible portion is seen from a side in the direction of the axis be larger than an area in a case where the tip end part of each plate spring bonding projection part is seen from the side in the direction of the axis. Thus, the jig can be easily abutted against the projection parts in the direction of the axis. In addition, in this manner, the visible portion (the portion supported by the jig from the object side) can be comparatively increased in size and thus the camera module holder can be stably supported by the jig.

According to at least an embodiment of the present invention, it is desirable that the plate spring be provided with: a movable member side linking part that is fixed to the movable member side plate spring fixing part; a supporting member side linking part that is fixed to the supporting member on an outer circumferential side of the movable member side linking part; and a meandering part positioned between the holding part and the supporting member in a radial direction that is orthogonal to the axis, the meandering part being configured to interconnect the movable member side linking part and the supporting member side linking part; the meandering part be provided with: a first extension portion extending to one circumferential side on an outer circumferential side of the holding part from a linking portion that is positioned outside in a radial direction of the plate spring bonding projection part in a movable member side linking part; a first return portion curving to another circumferential side from a tip end of the first extension portion toward an outer circumferential side; a second extension portion extending from a tip end of the first return portion to another circumferential side on an outer circumferential side of the first extension portion and reaching another circumferential side more significantly than the plate spring bonding projection part; and a second return portion curving one circumferential side from a tip end of the second extension portion to an outer circumferential side; and the projection part, on one circumferential side more significantly than the plate spring bonding projection part at the periphery of the axis, be provided in an angular range more proximal to the plate spring bonding projection part than a center of one end in the circumferential direction in the plate spring bonding projection part and the first return portion.

The first extension portion that is the most proximal to the holding part in the meandering part is likely to interfere with the projection part provided in the holding part when the movable member swings and then the plate spring deforms. However, of the first extension portion, in the angular range that is more proximal to the plate spring bonding projection part than the center relative to one circumferential end in the plate spring bonding projection part and the first return portion, a displacement from the side of the holding part (inner circumferential side) when the movable member swings is smaller in comparison with any other portion. Therefore, the projection part is provided in such an angular range, whereby, even in a case where the movable member swings and then the plate spring slackens, interference between the plate spring and the projection part can be prevented.

According to at least an embodiment of the present invention, it is desirable that the movable member side linking part be annular; the plate spring bonding projection part be provided with the plate spring boding projection part in plurality that are provided at equal angular intervals at the periphery of the axis; the meandering part be provided with the meandering part in plurality that are provided at equal angular intervals, the plurality of meandering parts being positioned on an outer circumferential side of each plate spring bonding projection part; and the projection part have the projection part in plurality that are provided at equal angular intervals at the periphery of the axis. Thus, when the jig is caused to abut against the plurality of projection parts, the weight of the camera module holder can be uniformly received by each projection part. Accordingly, the camera module holder can be stably supported by the jig.

According to at least an embodiment of the present invention, in an optical unit with shake correction function, a jig is caused to abut in a direction of an axis against a visible portion that is provided in a swingable camera module holder so as to be thereby able to swingably support the camera module holder. Therefore, the attachment work of attaching a camera module to a holding part of the camera module holder can be easily carried out.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a perspective view when an optical unit to which at least an embodiment of the present invention is applied is seen from an object side;

FIG. 2 is a sectional view of the optical unit taken along the line A-A of FIG. 1;

FIG. 3 is an exploded perspective view when the optical unit of FIG. 1 is seen from the object side;

FIG. 4 is an exploded perspective view of the optical unit of FIG. 1 when seen from a counter-object side;

FIG. 5 is an exploded perspective view of a counter-object side portion of a fixing member;

FIG. 6 is an exploded perspective view of a movable member and a holder when seen from the object side;

FIG. 7 is an exploded perspective view of the movable member and the holder when seen from the counter-object side;

FIG. 8 is an exploded perspective view of the movable member when seen from the object side;

FIG. 9 is an exploded perspective view of the movable member when seen from the counter-object side;

FIG. 10 is a sectional view of the optical unit when taken along a plane orthogonal to an axis;

FIGS. 11A-11B are illustrative views of a plate spring; and

FIG. 12 is a sectional view of the optical unit when taken along the axis and a plane that passes through a flexible printed circuit board.

FIG. 13 is a flowchart of a method for manufacturing the optical unit; and

FIG. 14 is an illustrative view of the steps of attaching a camera module.

### DETAILED DESCRIPTION

Hereinafter, an embodiment of an optical unit to which the present invention is applied will be described with reference to the accompanying drawing. In the present specification, three axes X, Y, and Z correspond to the related directions that are respectively orthogonal to each other, one side in the X axis direction is designated by +X and the other side by −X; one side in the Y axis direction is designated by +Y and the other side by −Y; and one side in the Z axis direction is designated by +Z and the other side by −Z. The Z axis direction is coincident with a direction of an axis of an optical module. The +Z direction corresponds to an object side in the direction of the axis of the optical module, and the −Z direction corresponds to a counter-object side (image side) in the direction of the axis. The axis of the optical module is coincident with an optical axis of the optical module.

(Entire Configuration)

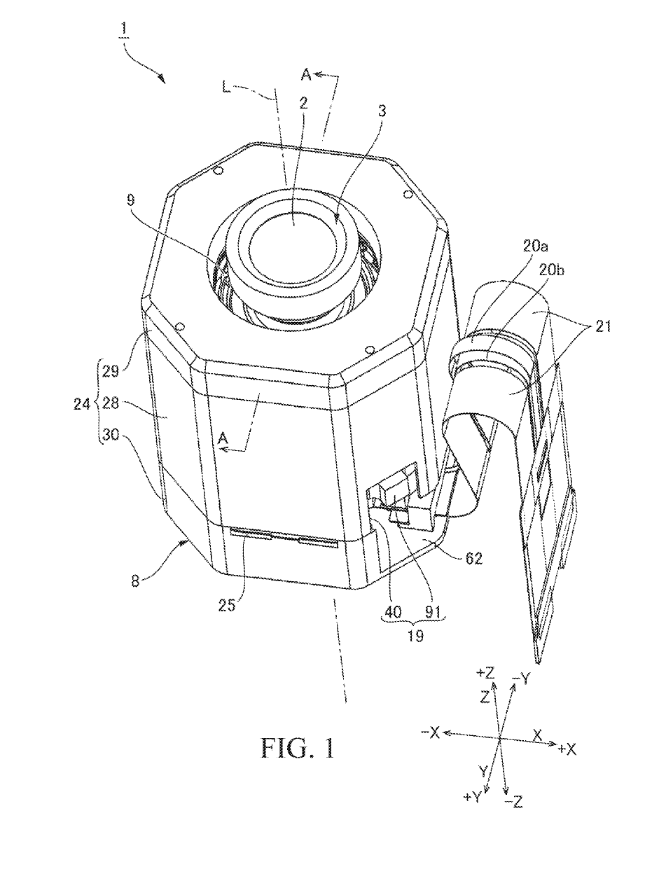

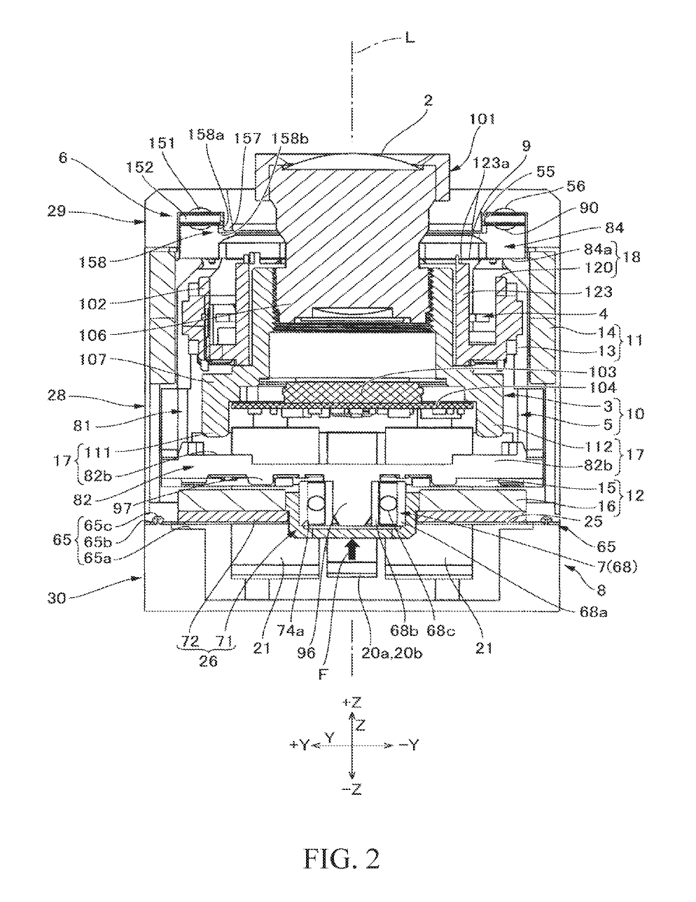

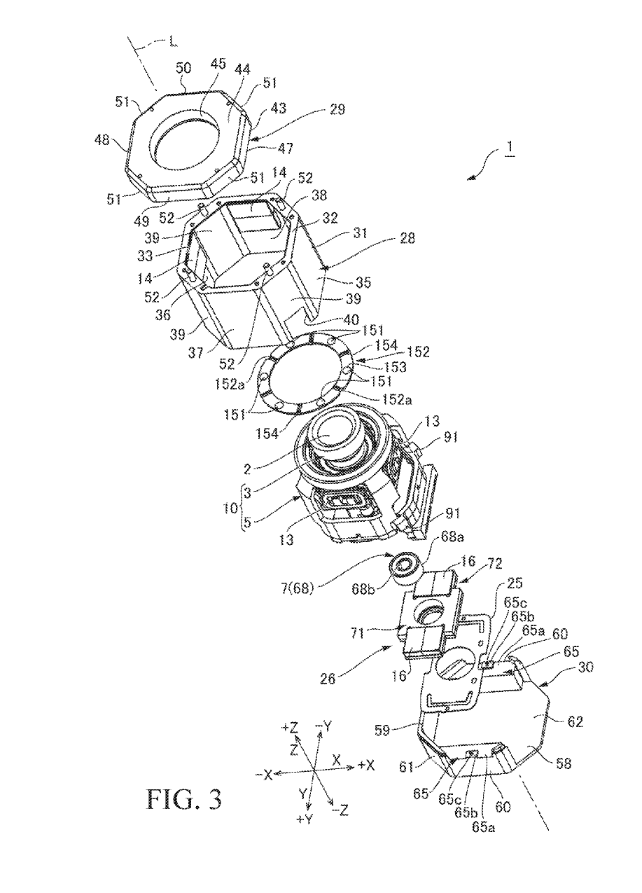

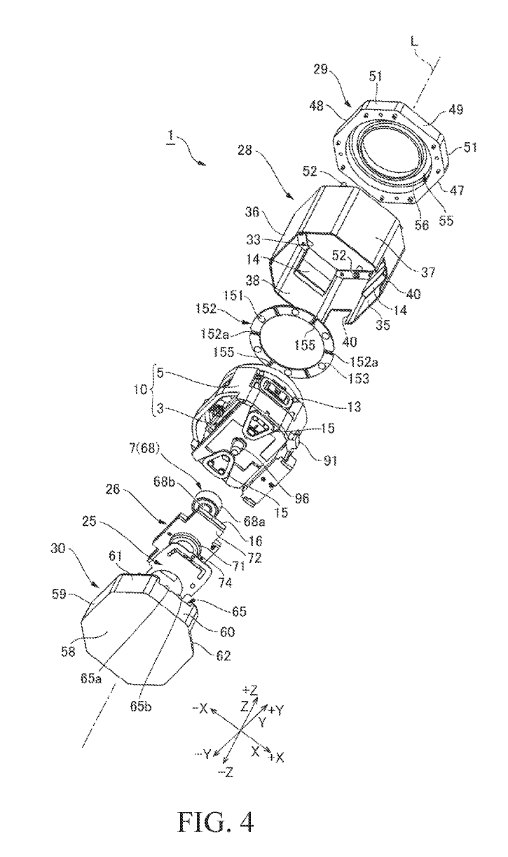

FIG. 1 is a perspective view of an optical unit to which at least an embodiment of the present invention is applied when seen from the object side. FIG. 2 is a sectional view of the optical unit taken along the line A-A of FIG. 1. FIG. 3 is an exploded perspective view of the optical unit of FIG. 1 when seen from the object side. FIG. 4 is an exploded perspective view of the optical unit of FIG. 1 when seen from the counter-object side. An optical unit 1 shown in FIG. 1 is used as an optical device in a cellular phone with camera or a drive recorder, for example, or an optical device in an action camera or a wearable camera mounted on a mobile object such as a helmet, a bicycle, or a radio controlled helicopter. In such an optical device, if a vibration of the optical device occurs at the time of imaging, a disturbance occurs in a picked up image. The optical unit 1 corresponds to an optical unit with shake correction function configured to correct tilt of an optical element 2 in order to avoid tilting of the picked up image.

As shown in FIG. 2, the optical unit 1 is provided with: a movable member 3 (optical module) provided with an optical element 2; a swingable supporting mechanism 4 configured to swingably support the movable member 3; and a holder 5 configured to support the movable member 3 via the swingable supporting mechanism 4. In addition, the optical unit 1 is provided with: a first rotation supporting mechanism 6 and a second rotation supporting mechanism 7 configured to rotatably support the holder 5; and a fixing member 8 configured to support the holder 5 via the first rotation supporting mechanism 6 and the second rotation supporting mechanism 7. Further, the optical unit 1 is provided with a plate spring 9 that is overhung by the movable member 3 and the holder 5.

The swingable supporting mechanism 4 is configured to swingably support the movable member 3 between a reference position in which a predetermined axis L and an optical axis of the optical element 2 are coincident with each other and a tilt position in which the optical axis tilts relative to the axis L. The swingable supporting mechanism 4 is a gimbal mechanism. The first rotation supporting mechanism 6 and the second rotation supporting mechanism 7 are configured to rotatably support the holder 5 at the periphery of the axis L. In other words, the first rotation supporting mechanism 6 and the second rotation supporting mechanism 7 are configured to rotatably support, at the periphery of the axis L, a second movable member 10 that consists of the holder 5 and the movable member 3 that is swingably supported by the holder 5. The first rotation supporting mechanism 6 and the second rotation supporting mechanism 7 are configured between the fixing member 8 and the holder 5. The second rotation supporting mechanism 7 is positioned in the −Z direction (counter-object side) more significantly than the first rotation supporting mechanism 6. The plate spring 9 is for defining the reference position.

In addition, the optical unit 1 is provided with: a magnetic driving mechanism 11 for swing configured to swing the movable member 3; and a magnetic driving mechanism 12 for rolling configured to rotate the holder 5 (second movable member 10). The magnetic driving mechanism 11 for swing is provided with: a swing driving coil 13 that is held by the movable member 3; and a swing driving magnet 14 that is held by the fixing member 8. The swing driving coil 13 and the swing driving magnet 14 respectively oppose to each other in a radial direction that is orthogonal to the axis L. The magnetic driving mechanism 12 for rolling is provided with: a rolling driving coil 15 that is held by the holder 5; and a rolling driving magnet 16 that is held by the fixing member 8. In the present embodiment, the rolling driving coil 15 and the rolling driving magnet 16 respectively oppose to each other in the X axis direction (direction of the axis).

Further, the optical unit 1 is provided with: a first stopper mechanism 17 and a second stopper mechanism 18 that define a swinging range of the movable member 3; and a third stopper mechanism 19 (refer to FIG. 1) configured to define a rotation range of the holder (second movable member). Furthermore, the optical unit 1 is provided with a flexible printed circuit board 20a, 21b, 21. The flexible printed circuit board 20a is electrically connected to the rolling driving coil 15. The flexible printed circuit board 20b is electrically connected to the swing driving coil 13. The flexible printed circuit board 21 is electrically connected to a board 104 that the movable member 3 holds.

(Fixing Member)

As shown in FIG. 1. FIG. 3, and FIG. 4, the fixing member 8 has: a fixing member main body 24 configured by assembling three casings 28, 29, 30; a plate spring 25 (spring member) that is fixed to the fixing member main body 24; and a movable holder 26 that is supported by the fixing member main body 24 via the plate spring 25. The movable holder 26 is supported in a movable state in the Z axis direction. As shown in FIG. 1, the fixing member main body 24 is provided with: a cylindrical casing 28 formed in a substantially octagonal shape when seen from the side in the Z axis direction (direction of the axis); an object side casing 29 that is assembled in the +Z-direction (object side) relative to the cylindrical casing 28; and a counter-object side casing 30 that is assembled in the −Z direction (counter-object side) relative to the cylindrical casing 28. The cylindrical casing 28 is formed of a magnetic material. The object side casing 29 and the counter-object side casing 30 each are formed of a resin material.

As shown in FIG. 3, the cylindrical casing 28 is provided with: a cylindrical body part 31 formed in an octagonal shape; and a frame-shaped end plate part 32 extending to the inside from an end part in the +Z direction of the body part 31. In a center of the end plate part 32, a substantially octagonal aperture part 33 is formed. The body part 31 is provided with: side plates 35, 36 respectively opposing to each other in the X axis direction; side plates 37, 38 respectively opposing to each other in the Y axis direction; and a side plate 39 provided at four corners, each of which tilts at an angle of 45 degrees relative to the X axis direction and the Y axis direction. As shown in FIG. 3 and FIG. 4, on the inner circumferential faces of the side plates 35, 36 respectively opposing to each other in the X axis direction and the side plates 37, 38 respectively opposing to each other in the Y axis direction, swing driving magnets 14 are respectively fixed. In addition, as shown in FIG. 4, in two side plates 39 that are positioned in the +X direction of four side plates 39, rectangular cutout parts 40 are respectively formed. The cutout parts 40 each are formed in a shape in which an end edge in the −Z direction of the side plate 39 is cut away in the +Z direction.

The object side casing 29 is provided with: a cylindrical body part 43 abutting against the end plate part 32 of the cylindrical casing 28; and an end plate part 44 extending to the inside from an end part in the +Z direction of the body part 43. In a center of the end plate part 44, a circular aperture part 45 is formed. As shown in FIG. 4, an inner circumferential face of the body part 43 is a substantially circular shape, and is a substantial octagonal shape when seen from the side in the Z axis direction. An outer circumferential face of the body part 43 is provided with: side faces 47, 48 respectively opposing to each other in the X axis direction; side faces 49, 50 respectively opposing to each other in the Y axis direction; and a side face 51 provided at four corners, each of which tilts at an angle of 45 degrees relative to the X axis direction and the Y axis direction. The object side casing 29 is fixed to the cylindrical casing 28 by way of four head screws 52 passing through the end plate part 32 of the cylindrical casing 28 in the −Z direction and screwed to the body part 43. Here, a face in the −Z direction of the end plate part 44 is an annular face that is coaxial to the axis L, and is also a fixing member side opposing part 55 that corresponds to the holder 5 in the Z axis direction. In the fixing member side opposing part 55, a fixing member side annular groove 56 is provided. The fixing member side annular groove 56 is coaxial to the axis L, and the related sectional shape is an arc.

The counter-object side casing 30, as shown in FIG. 3, is provided with: an end plate part 58 formed in a substantially octagonal shape and orthogonal to the axis L; a wall part 59 rising in the +Z direction from an end edge (edge) in the −X direction of the end plate part 58; two wall parts 60 rising in the +Z direction from an end edge (edge) in the −Y direction of the end plate part 58 and an end edge (edge) in the +Y direction and respectively opposing to each other in the Y axis direction; and two wall parts 61 positioned between the wall part 59 and a respective one of the two wall parts 60, each of which tilts at an angle of 45 degrees relative to the X axis direction and the Y axis direction. Here, a wall part is not provided at an end edge (edge) in the +X direction of the end plate part 58, and an aperture part 62 is provided between edges in the +X direction of the two wall parts 60 respectively opposing to each other in the Y axis direction. As shown in FIG. 1, the aperture part 62 is a drawing outlet of the flexible printed circuit boards 20a, 20b, 21.

At end portions in the +Z direction of the two wall parts 60 respectively opposing to each other in the Y axis direction, plate spring fixing parts 65 that fix both end parts in the Y direction of the plate spring 25 are respectively provided. Each plate spring fixing part 65 is provided with: an end face 65a spreading in the X axis direction and the Y axis direction in an offset location in the −Z direction more significantly than a tip end of the wall part 59; a rectangular projection part 65b that is formed at an edge portion on the outer circumferential face of each end face 65a; and a circular projection 65c that projects in the +Z direction from a center of the rectangular projection part 65b.

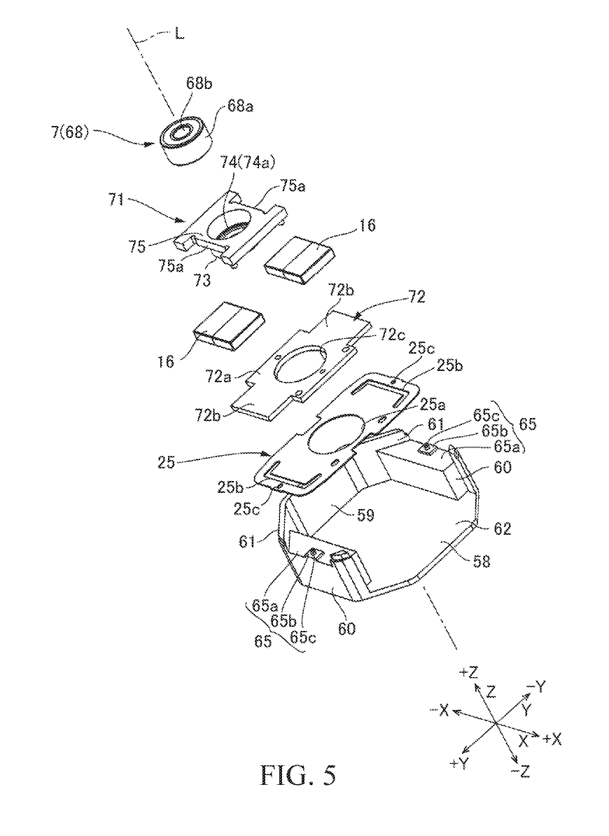

FIG. 5 is an exploded perspective view of counter-object side portion (second rotation supporting mechanism 7, movable holder 26, plate spring 25, and counter-object side casing 30) of the fixing member 8. As shown in FIG. 5, the movable holder 26 is provided with: an outer ring 68a of a ball bearing 68 that configures the second rotation supporting mechanism 7; and a movable holder main body member 71 configured to hold two rolling driving magnets 16. In addition, the movable holder 26 is provided with a yoke 72 that abuts against the movable holder main body member 71 in the −Z direction. The movable holder main body member 71 is provided with: a cylinder part 73 with which the outer ring 68a engages, on the inner circumferential side; a circular ring-shaped part 74 projecting to the inner circumferential side from an end in the −Z direction of the cylinder part 73; and a magnet holding part 75 spreading in the outer circumferential side from an end portion in the +Z direction of the cylinder part 73. The circular ring-shaped part 74 is provided with an annular abutment part 74a that abuts against the outer ring 68a in the −Z direction. The magnet holding part 75 is provided with a pair of rectangular depression part 75a that depress from both sides in the Y axis direction to the inside in the radial direction. Two rolling driving magnets 16 are respectively engaged into the depression parts 75a from the outer circumferential side and then are held by the movable holder main body member 71.

A yoke 72 is formed of a magnetic material. The yoke 72 is provided with: a rectangular wide portion 72a that is positioned at a center portion in the Y axis direction; and a rectangular portion 72b extending from the wide portion 72a to both sides in the Y axis direction. A width of the rectangular portion 72b in the X axis direction is smaller than a width of the wide portion 72a. In a center of the wide portion, a circular hole 72c is provided. In the yoke 72, the cylinder part 73 of the movable holder main body member 71 is inserted into the circular hole 72c from the side in the +Z direction; the wide portion 72a abuts against the movable holder main body member 71 in the −Z direction; and the rectangular portion 72b abuts against the rolling driving magnet 16 in the −Z direction. A contour shape of the yoke 72 is coincident with a contour shape of the movable holder main body member 71 having held the rolling driving magnet 16 by itself when seen from the side in the Z axis direction. Here, in the yoke 72, an adhesive agent is applied to a portion which the rolling driving magnet 16 abuts against, and the rolling driving magnet 16 is fixed to the yoke 72 as well.

The plate spring 25 has a substantially rectangular contour shape that is elongated in the Y axis direction, the plate spring 25 has a through hole 25a through which the cylinder part 73 of the movable holder main body member 71 can be inserted into the center in the Y axis direction. In addition, the plate spring 25 has a U-shaped slit 25b on both sides in the Y axis direction while the through hole 25a is sandwiched therebetween. The shape of the two slits 25b is adapted to frame an end portion in the Y axis direction of the yoke 72 when the yoke 72 and the plate spring 25 are overlapped each other. In addition, the plate spring 25 has a fixing hole 25c for fixing the plate spring 25 to the spring fixing part 65 at each end portion in the Y axis direction (outer in the Y axis direction than the two slits 25b).

The plate spring 25 is supported by the plate spring fixing part 65 in a state in which the projection 65s is inserted into the fixing hole 25c and the center portion at each end portion in the Y axis direction is placed on the projection part 65b. In addition, as shown in FIG. 1, the cylindrical casing 28 and the counter-object side casing 30 are assembled with each other, and the plate spring 25 is thereby sandwiched between the cylindrical casing 28 and the counter-object side casing 30 and then is fixed to the fixing member 8. Here, as shown in FIG. 2, when the movable holder 26 is supported by the fixing member 8, it follows that the plate spring 25 imparts a fixing force F of biasing the movable holder 26 to the +Z axis direction (object side). That is, it follows that the plate spring 25 slackens in the −X direction (counter-object side) at a portion on the inner circumferential side more significantly than each end portion in the Y axis direction that is fixed to the plate spring fixing part 65, and biases the movable holder 26 in the +Z axis direction by its elastically resilient force.

(Holder)

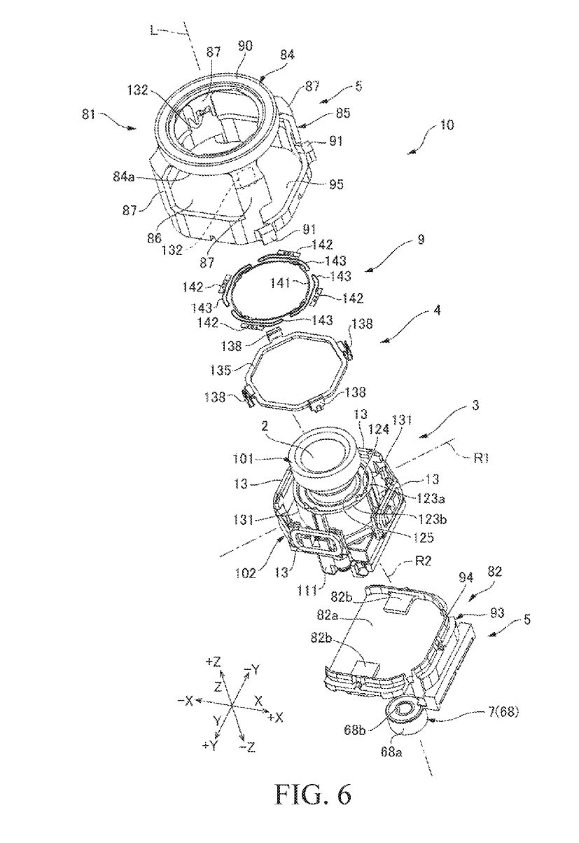

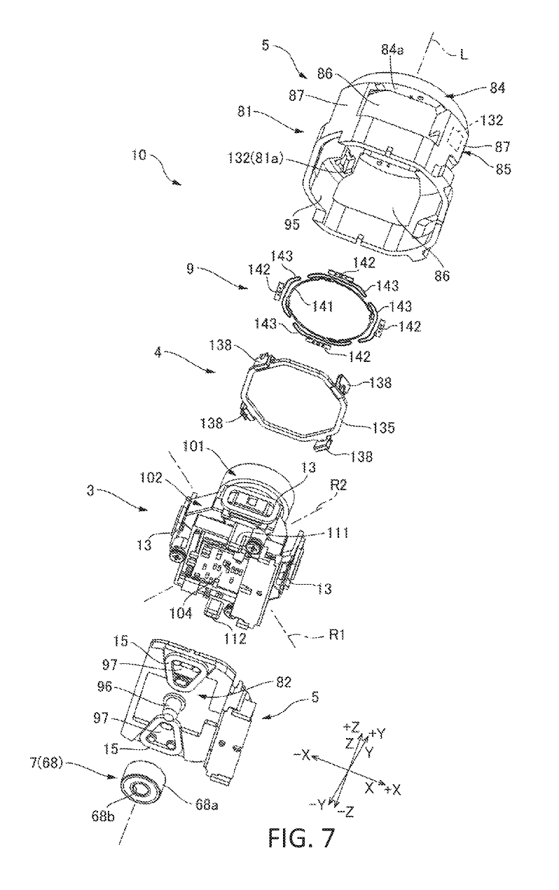

FIG. 6 is an exploded perspective view of the movable member 3 and the holder 5 (second movable member 10) when seen from a side in the +Z direction. FIG. 7 is an exploded perspective view of the movable member 3 and the holder 5 (second movable member 10) when seen from the side in the −Z direction. As shown in FIG. 6, the holder 5 is provided with: a holder main body member 81 (supporting member) positioned on an outer circumferential side of the movable member 3 and configured to support the movable member 3; and a holder bottom plate member 82 fixed to the holder main body member 81 in the −Z direction and opposing the movable member 3. The holder main body member 81 and the holder bottom plate member 82 are made of a resin.

As shown in FIG. 6, the holder main body member 81 is provided with: an annular holder side opposing part 84 opposing to an annular fixing member side opposing part 55 in a fixing member 8 (object side casing 29) at an end in the +Z direction; and a holder body part 85 that is configured in the −Z direction of the holder side opposing part 84. The holder body part 85 is provided with: four window parts 86 arranged in a circumferential direction; and four vertical frame parts 87 configured to partition the window parts 86 that are adjacent to each other in the circumferential direction. Two window parts 86 of the four window parts 86 open in the X axis direction, and the other two open in the Y axis direction. The four vertical frame parts 87 each are disposed in an angular location between the X axis direction and the Y axis direction.

The holder side opposing part 84 is an annular face on which an end face in the +Z direction is orthogonal to the axis L, and on the annular face, a holder side annular groove 90 is provided. The holder side annular groove 90 opposes in the Z axis direction to the fixing member side annular groove 56 that is provided in the holder side opposing part 84. The holder side annular groove 90 is coaxial to the axis L, and the related sectional shape is an arc. The holder side opposing part 84 is provided with an annular end face 84a that is orthogonal to the axis L, the annular end face being oriented in the −Z direction.

In an end portion in the −Z direction in the holder body part 85, a projection 91 that projects in an intermediate direction between the +X direction and the +Y direction and a projection 91 that projects in a middle direction between the +X direction and −Y direction are provided.

The holder bottom plate member 82 is provided with an opposing face 82a that is orthogonal to the axis L, the opposing face opposing to the movable member 3 in the −Z direction. At both end portions of the Y axis direction in the opposing face 82a, a rectangular projection portion 82b that projects in the +Z direction is provided. At an outer circumferential edge of the opposing face 82a of the holder bottom plate member 82, a stepped part 93 that surrounds the bottom plate from both side in the Y axis direction and from the side of the +X direction is provided. The stepped part 93 is provided an annular projection part 94 that projects in the +Z direction on the inner circumferential side. When the holder bottom plate member 82 is fixed to the holder main body member 81, the annular projection part 94 engages into an aperture part 95 in the −Z direction of the holder main body member 81 (holder body part 85).

In addition, the holder bottom plate member 82, as shown in FIG. 2, is provided with a shaft part 96 that projects in the −Z direction. The shaft part 96 is provided so as to coaxial to the axis L. The shaft part 96 is configured to hold an inner ring 68b of a ball bearing 68 on an outer circumferential side. An end face of the +Z direction in the inner ring 68b abuts against the holder bottom plate member 82. In addition, the holder bottom plate member 82 is provided with a rolling driving coil holding part 97 on both sides on which the shaft part 96 are sandwiched therebetween in the Y axis direction. The rolling driving coil 15 is held by the rolling driving coil holding part 97 in the −Z direction. Here, a flexible printed circuit board 20a is electrically connected to the rolling driving coil 15 that is held by the holder bottom plate member 82.

(Movable Member)

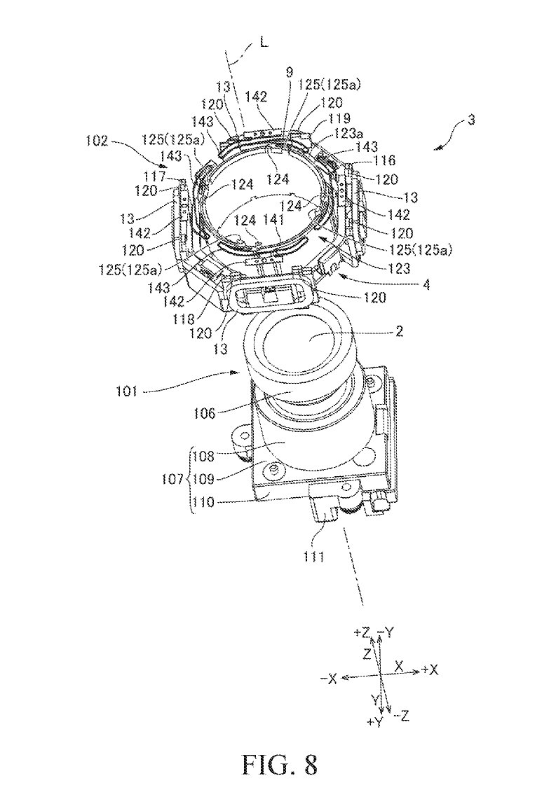

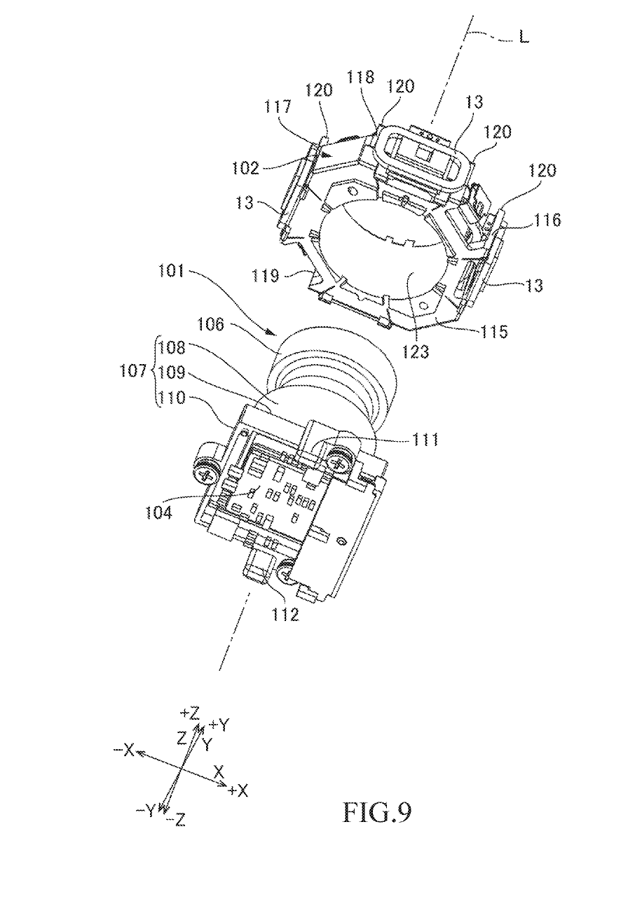

FIG. 8 is an exploded perspective view of the movable member 3, the swingable supporting mechanism 4 and the plate spring 9 when seen from a side in the +Z direction (object side). FIG. 9 is an exploded perspective view of the movable member 3, the swingable supporting mechanism 4, and the plate spring 9 when seen from a side in the −Z direction (counter-object side). As shown in FIG. 8 and FIG. 9, the movable member 3 is provided with: a camera module 101; and a camera module holder 102 configured to hold the camera module 101 from an outer circumferential side. The camera module 101, as shown in FIG. 2, has: an optical element 2; and an image pickup element 103 that is positioned on an optical axis of the optical element 2. The image pickup element 103 is mounted on a board 104 on which an electronic device such as a gyroscope or a signal processing circuit has been mounted. In addition, the camera module 101 has: a mirror cylinder member 106 configured to hold the optical element 2; and a frame 107 configured to hold the mirror cylinder member 106 and the board 104. As shown in FIG. 8, the frame 107 is provided with: a cylinder part 108 configured to hold, on an inner circumferential side, an end portion in the −Z direction of the cylinder part 108; and a rectangular plate part 109 spreading from an end edge in the −Z direction of the cylinder part 108 to the outer circumferential side; and a rectangular tube part 110 extending in the −Z direction from an outer circumferential edge of the plate part 109. As shown in FIG. 9, the board 104 is held on the inner circumferential side of the rectangular tube part 110.

In the rectangular tube part 110, in the Y axis direction, an optical axis (axis L), an image pickup element 103, and a first projection part 111 for stopper and a second projection part 112 for stopper that project in the −Z direction on both side on which the board 104 is sandwiched therebetween are provided.

As shown in FIG. 9, the camera module holder 102 is provided with: a bottom plate part 115 formed in a substantially octagonal shape when seen from the side in the Z axis direction; a pair of wall parts 116, 117 rising in the +Z direction and extending in the Y axis direction on both ends in the X axis direction of the bottom plate part 115; and a pair of wall parts 118, 119 rising in the +Z direction and extending in the X axis direction on both sides in the Y axis direction of the bottom plate part 115. On end faces in the +Z direction in the respective wall parts 116, 117, 118, 119, two second projection parts 120 for stopper that project in the +Z direction are provided. The two second projection parts 120 for stopper respectively project from both end portions in the circumferential directions in each of the wall parts 116, 117, 118, 119. To each of the wall parts 116, 117, 118, 119, the swing driving coil 13 is fixed.

In addition, the camera module holder 102 is provided with a cylindrical holding part 123 rising in the +Z direction from an edge of a circular through hole that is formed at a center of the bottom plate part 115. On an annular end face 123a in the +Z direction of the holding part 123, plate spring bonding projection parts 124 for fixing the plate spring 9 are provided in four locations at equal angular intervals. As shown in FIG. 6, in the annular end face 123a, the outer circumferential side of the plate spring bonding projection part 124 corresponds to a movable member side plate spring fixing part 123b configured to fix the plate spring 9. The plate spring 9 is fixed to the movable member side plate spring fixing part 123b via an adhesive layer.

As shown in FIG. 8, in the holding part 123, supporting projection parts 125 (visual portion, projection parts) are further provided. The support projection parts 125 each is a projection part for supporting the camera module holder 102 by a jig from the side in the +Z direction at the time of assembling the second movable member 10 (movable member 3 and holder 5). The supporting projection parts 125 are provided in four locations at equal angular intervals. Angular locations in which the respective spring bonding projection parts 124 have been formed are respectively different from angular locations in which the respective supporting projection parts 125 have been formed. In addition, each supporting projection part 125 is provided on the inner circumferential side more significantly than the movable member side plate spring fixing part 123b on the annular end face 123a in the +Z direction of the holding part 123. Further, each supporting projection part 125 projects in the +Z direction from an end portion on the inner circumferential side of the annular end face 123a. Here, tip end faces 125a (tip end parts) of the four supporting projection parts 125 each are obtained as a visual portion configured to enable a visual check without an occurrence of an overlap with respect to the camera module 101, the swingable supporting mechanism 4, and the holder 5 when seen from the side in the +Z direction.

Here, although not shown in FIG. 8, the flexible printed circuit board 20b is fixed to the camera module 101, and is electrically connected to the swing driving coil 13 that is fixed to the respective wall parts 116, 117, 118, 119 of the camera module holder 102. The flexible printed circuit board 21 is fixed to the camera module 101, and is electrically connected to the board 104 that is held by the rectangular tube 110 of the camera module 101. The flexible printed circuit board 20b, 21 are drawn between the first projection part 111 for stopper and the second projection part 112 for stopper.

(Swingable Supporting Mechanism)

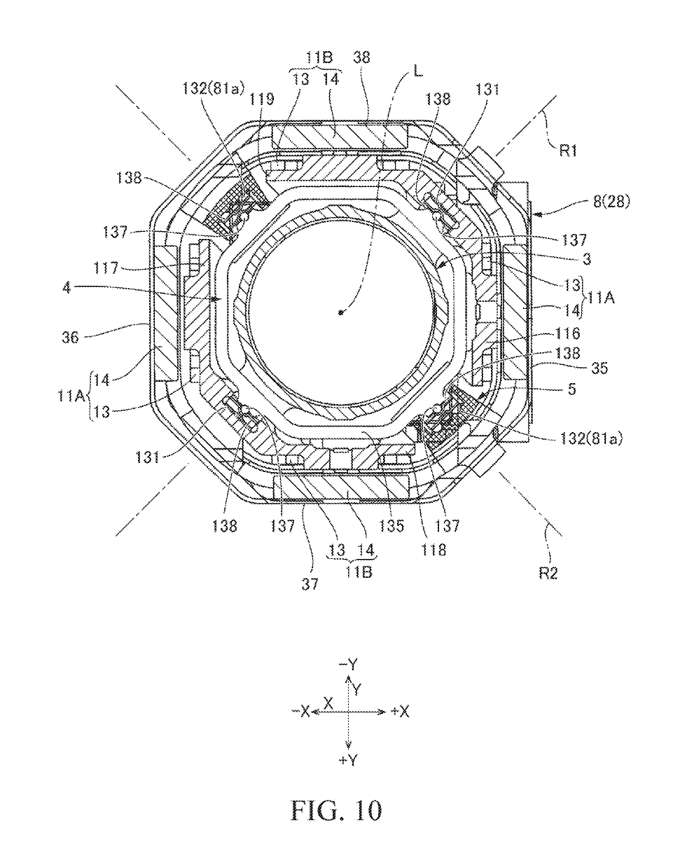

FIG. 10 is a sectional view of the optical unit 1 when taken along a plane that is orthogonal to the axis L, the plane passing through the swingable supporting mechanism 4. The swingable supporting mechanism 4 is arranged between the camera module holder 102 and the holder main body member 81. As shown in FIG. 6 and FIG. 7, the swingable supporting mechanism 4 is provided with: two first swingable supporting parts 131 that are provided in diagonal locations on a first axis R1 of the camera module holder 102; two second swingable supporting parts 132 that are provided in diagonal locations on a second axis R2 of the holder main body member 81; and a movable frame 135 that is supported by the first swingable supporting part 131 and the second swingable supporting part 132. Here, the first axis R1 and the second axis R2 each correspond to a direction tilting at an angle of 45 degrees relative to the X axis direction and the Y axis direction. Therefore, the first swingable supporting part 131 and the second swingable supporting part 132 each are disposed in an angular location between the X axis direction and the Y axis direction. As shown in FIG. 6 and FIG. 7, the second swingable supporting part 132 corresponds to a depression part 81a that is formed in an inside face of the holder main body member 81.

As shown in FIG. 10, the movable frame 135 corresponds to a plate-shaped spring formed in a substantially octagonal shape in planar view as seen from the side in the Z axis direction. On an outside face of the movable frame 135, metallic balls 137 are fixed by way of any means such as welding in four locations at the periphery of the axis L. These balls 137 respectively come into point contact with contact springs 138 held by the first swingable supporting part 131 that is provided in the camera module holder 102 and the second swingable supporting part 132 that is provided in the holder main body member 81. The contact spring 138 is a plate-shaped spring, the contact spring 138 held by the first swingable supporting part 131 is elastically deformable in the direction of the first axis R1, and the contact spring 138 held by the second swingable supporting part 132 is elastically deformable in the direction of the second axis R2. Therefore, the movable frame 135 is supported in a rotatable manner at the periphery of each of the two directions (the direction of the first axis R1 and the direction of the second axis R2) that are orthogonal to the Z axis direction.

(Plate Spring)

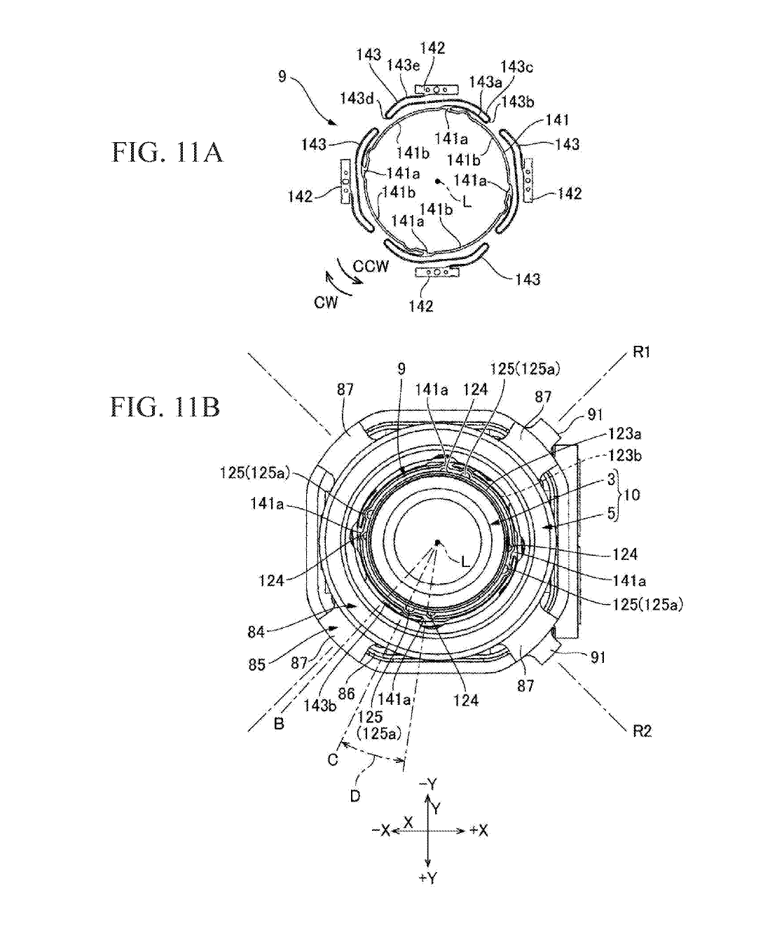

FIG. 11A is a plan view of the plate spring 9 when seen from the side in the Z axis direction, and FIG. 11B is a plan view of the movable member 3 and the holder 5 in a state in which the plate spring 9 is overhung when seen from the side in the +Z direction. As shown in FIG. 2, the plate spring 9 is overhung between the annular end face 123a of the holding part 123 of the camera module holder 102 (end face in the +Z direction) and the annular end face 84a oriented in the −Z direction in the holder side opposing part 84 of the holder main body member 81. The plate spring 9 defined a reference position of the movable member 3. That is, the position (reference position) of the movable member 3 (camera module 101) in a still state in which the magnetic driving mechanism 11 for swing is not driven is determined by the plate spring 9. As shown in FIG. 6, FIG. 7, and FIG. 11A, the plate spring 9 is a plate spring formed in the shape of a rectangular frame in which a metal plate has been machined.

As shown in FIG. 11A, the plate spring 9 is provided with: an annular movable member side linking part 141 that is fixed to the movable member side plate spring fixing part 123b of the holding part 123; four holder side linking part 142 (supporting body side linking part) that are fixed to an end face of the holder main body member 81; and a meandering part 143 that is positioned between the movable member side linking part 141 and each of the holder side linking parts 142 in a radial direction. The holder side linking parts 142 are disposed in two locations in which the optical axis L is sandwiched therebetween on both sides in the X axis direction and in two locations in which the optical axis L is sandwiched on both sides in the Y axis direction.

The movable member side linking part 141 is provided with: four link portions 141a having cutouts that are positioned on the outer circumferential sides of the four plate spring bonding projection parts 124 that are provided in the annular end faces 123a of the holding part 123; and connecting portions 141b formed in the shape of an arc and connecting the link portions 141a that are respectively adjacent to each other in the circumferential direction. Here, the movable member side linking part 141 is fixed to the annular end face 123a via an adhesive layer. Therefore, in the state in which the movable member side linking part 141 has been fixed to the annular end face 123a, the plate spring 9 is unstable in the +Z direction from the annular end face 123a. The four link portions 141a are respectively fixed to the spring bonding projection parts 124 via the adhesive layer. Therefore, in the state in which the link portions 141a have been fixed to the plate spring bonding projection parts 124, respectively, a gap is provided in a radial direction between the link portion 141a and the plate spring bonding projection part 124.

The meandering part 143, as shown in FIG. 11B, is provided with: a first extension portion 143a extending to one side (clockwise direction) in the circumferential direction on the outer circumferential side of the holding part 123 from the link portion 141a that is positioned on the outer circumferential side of the spring bonding projection part 124 in the state in which the movable member side linking part 141 has been fixed to the holding part 123; a first return portion 143b curving to the other side in the circumferential direction from a tip end of the first extension portion 143a to the outer circumferential side; a second extension portion 143c extending from a tip end of the first return portion 143b to the other side (counterclockwise direction) in the circumferential direction on the outer circumferential side of the first extension portion 143a from a tip end of the first return portion 143b; a second return portion 143d curving to one side in the circumferential direction from a tip end of the second extension portion 143c to the outer circumferential side; and a third extension portion 143e extending to one side (clockwise direction) on the outer circumferential side of the second extension portion 143c from a tip end of the second return portion 143d. The tip end of the third extension portion 143e is positioned at the other side more significantly than the plate spring bonding projection part 124, and is connected to the holder side linking part 142.

Here, the four supporting projection parts 125 that are provided on the annular end face 123a of the holding part 123 is positioned on the inner circumferential side more significantly than the movable member side plate spring fixing part 123b, and is spaced in a radial direction from the movable member side plate spring fixing part 123b. In addition, in the movable member side linking part 141 of the plate spring 9 that is fixed to the movable member side plate spring fixing part 123b, a cutout part is provided in a portion that is positioned on the outer circumferential side of each of the supporting projection parts 125, and is spaced in the radial direction between the movable member side linking part 141 and each supporting projection part 125. Further, the tip end parts 125a of the supporting projection parts 125 each are positioned on the side in the +Z direction more significantly than the movable member side plate spring fixing part 123b and are positioned on the side in the −Z direction more significantly than a tip end part of the plate spring bonding projection part 124. In addition, the supporting projection parts 125 each are provided in an angular range D that is more proximal to the plate spring bonding projection part 124 than a center C between the plate spring bonding projection part 124 and one circumferential end (angular location B) in the first return portion 143b, in one circumferential end (clockwise direction) more significantly than the plate spring bonding projection part 124 at the periphery of the axis L.

(First Stopper Mechanism and Second Stopper Mechanism)

Here, as shown in FIG. 2, when the movable member 3 is swingably held by the holder 5, the first projection part 111 for stopper and the second projection part 112 for stopper, each of which projects in the −Z direction from the movable member 3 (camera module 101); and a rectangular projection portion 82b that is provided on the opposing face 82a of the holder bottom plate member 82 oppose in the Z axis direction and configures the first stopper mechanism 17 configured to define a swinging range of the movable member 3. That is, if the movable member 3 is set in a tilt position exceeding the swinging range, the first projection part 111 for stopper and the second projection part 112 for stopper abut against the projection portion 82b, and restrict any more tilting of the movable member 3. Further, in the first stopper mechanism 17, in a case where the movable member 3 has been moved in the −Z direction by way of an external force, the first projection part 111 for stopper and the second projection part 112 for stopper abut against the projection portion 82b, and restrict any more movement of the movable member 3 in the −Z direction.

In addition, when the movable member 3 has been swingably held by the holder 5, the second projection part 120 for stopper, that is provided in the movable member 3 (camera module holder 102), and the annular end face 84a in the −Z direction of the holder side opposing part 84 opposes in the Z axis direction and configures the second stopper mechanism 18 configured to define a second swinging range of the movable member 3. That is, if the movable member 3 is set in a tilt position exceeding the second swinging range, the second projection part 120 for stopper abuts against the annular end face 84a, and restricts any more tilting of the movable member 3. Further, in the second stopper mechanism 18, in a case where the movable member 3 has been moved in the +Z direction by way of an external force, the second projection part 120 for stopper abuts against the annular end face 84a, and restricts any more movement of the movable member 3 in the +Z direction.

Incidentally, the second swinging range that the second stopper mechanism 18 defines is smaller than the swinging range that the first stopper mechanism 17 defines, and is included in the swinging range that the first stopper mechanism 17 defines. Therefore, while the movable member 3 swings in the second swinging range, the first projection part 111 for stopper or the second projection 112 for stopper does not abut against the projection portion 82b.

(First Rotation Supporting Mechanism and Second Rotation Supporting Mechanism)

Next, the first rotation supporting mechanism 6 and the second rotation supporting mechanism 7 configured to rotatably support the holder 5 at the periphery of the axis L will be described. As shown in FIG. 2, FIG. 3, and FIG. 4, the first rotation supporting mechanism 6 is provided with: a plurality of balls 151 (roller); and a retainer 162 configured to hold the balls 151, between the fixing member side opposing part 55 and the holder side opposing part 84. As shown in FIG. 3 and FIG. 4, the retainer 152 has a plurality of through holes 153 that are arranged at equal intervals in the circumferential direction. Each of the plurality of ball 151 is inserted into the fixing member side annular groove 56 and the holder side annular groove 90 in a state in which each ball is disposed inside of a respective one of the plurality of through holes 153. Lubricating oil is applied to the inner circumferential face of each of the fixing member side annular groove 56 and the holder side annular groove 90. In the present embodiment, the number of balls 151 and through holes 153 is six. The balls 151 roll the fixing member side annular groove 56 and the holder side annular groove 90 in a state in which these balls are positioned inside of the through holes 153.

In addition, the retainer 152 is provided with: a first projection part 154 that projects toward the fixing member side opposing part 55; and a second projection part 155 that projects toward the holder side opposing part 84 between the two through holes 153 that are adjacent to each other in the circumferential direction. As shown in FIG. 3, the first projection part 154 extends in the radial direction, and is provided with an arc face that projects in the +Z direction from each end in the circumferential direction to a center. As shown in FIG. 4, the second projection part 155 extends in the radial direction, and is provided with an arc face that projects in the −Z direction from each end in the circumferential direction to the center. A center portion in the circumferential direction of the first projection part 154 is capable of coming into slide contact with an edge portion on the inner circumferential side and an edge portion on the outer circumferential side of the fixing member side annular groove 56 in the fixing member side opposing part 55. A center portion in the circumferential direction of the second projection part 155 is capable of coming into slide contact with an edge portion on the inner circumferential side and an edge portion on the outer circumferential side of the holder side annular groove 90 in the holder side opposing part 84. Further, the retainer 152 has cutout parts 152a in two spaced locations of an outer circumferential edge. In the present embodiment, the cutout parts 152a are provided at angular intervals of 180 degrees.

Here, as shown in FIG. 2, at an end portion of the inner circumferential side more significantly than the fixing member side annular groove 56 in the fixing member side opposing part 55, an annular projection part 157 that projects in the −Z direction is provided. On the other hand, at an end portion of the inner circumferential side more significantly than the holder side annular groove 90 in the holder side opposing part 84, an annular stepped part 158 depressed in the −Z direction and configured to receive a tip end portion of the annular projection part 157 is provided. The annular stepped part 158 is provided with: an annular radial opposing face 158a that opposes at small intervals from the outer circumferential side at the tip end portion of the annular projection part 157; and an annular axial opposing face 158b that opposes at small intervals from the side in the Z axis direction at the tip end portion of the annular projection part 157. A space between the annular projection part 157 and the radial opposing face 158a and a space between the annular projection part 157 and the axial opposing face 158b communicate with each other, and these spaces configure a rabbi squirrel seal. This rabbi squirrel seal prevents or restricts entry of dust between the fixing member side opposing part 55 on which the ball 151 rolls and the holder side opposing part 84.

Next, the ball bearing 68 of the second rotation supporting mechanism 7, as shown in FIG. 2, is provided with: an inner ring 80b that is held on the outer circumferential side of the shaft part 96 of the holder 5 (holder bottom plate member 82); an outer ring 68a that is positioned on the outer circumferential side of the inner ring 68b; and a plurality of balls 68c that roll between the inner ring 68b and the outer ring 68a in the radial direction. The outer ring 68a is held by the movable holder 26.

Here, the plate spring 25 is configured to impart, to the ball bearing 68, a given pressure (biasing force F) that is applied in the +Z direction. That is, the plate spring 25 is configured to bias the movable holder 26 toward the holder bottom plate member 82 to thereby bias the outer ring 68a that is held by the holder 5 to the holder bottom plate member 82. In this manner, the inner ring 68b and the outer ring 68a are positioned with respect to a relative location in the Z axis direction with reference to the holder bottom plate member 82. In addition, by the given pressure (biasing force F of the plate spring 25), a state in which the outer ring 68a has abutted against the holder bottom plate member 82 is maintained. In this manner, rotation of the holder 5 that is supported by the second rotation supporting mechanism 7 is stabilized.

Further, the plate spring 25 is configured to bias the holder 5 toward the fixing member side opposing part 55 of the fixing member 8 (object side casing 29) via the movable holder 26 and the outer ring 68a. In this manner, the plate spring 25 imparts, to the first rotation supporting mechanism 6, a given pressure (biasing force F of FIG. 2) that is applied in the +Z direction. That is, the plate spring 25 is configured to bias the holder side opposing part 84 toward the fixing member side opposing part 55 in the Z axis direction. In this manner, the holder side opposing part 84 and the fixing member side opposing part 55 are not spaced from each other in the Z axis direction and thus the ball 151 that is held by the retainer 152 does not slip off from a gap between the holder side annular groove 90 of the holder side opposing part 84 and the fixing member side annular groove 56 of the fixing member side opposing part 55, and the holder 5 smoothly rotates relative to the fixing member 8.

(Third Stopper Mechanism)

Here, as shown in FIG. 1, when the holder 5 has been rotatably supported by the fixing member 8, a projection 91 that is provided in the holder 5 (holder body part) is inserted into the cutout part 40 of the fixing member 8 (cylindrical casing 28) from the inner circumferential side. In this manner, the cutout part 40 of the fixing member 8 and the projection 91 of the holder 5 configure the third stopper mechanism 19 configured to restrict a rotation range at the periphery of the axis L of the holder 5 (second movable member 10). That is, in the holder 5, the projection 91 rotates in the cutout part 40 at the periphery of the axis L in a movable range in the circumferential direction.

(Magnetic Driving Mechanism for Swing)

Next, the magnetic driving mechanism 11 for swing, as shown in FIG. 10, is provided with a first magnetic driving mechanism 11A for swing and a second magnetic driving mechanism 11B for swing, both of which are provided between the movable member 3 and the fixing member 8. The first magnetic driving mechanism 11A for drive is provided in two sets, each of which consists of a swing driving magnet 14 and a swing driving coil 13 respectively opposing to each other in the X axis direction. The second magnetic driving mechanism 11B for swing is provided in two sets, each of which consists of the swing driving magnet 14 and the swing driving coil 13 respectively opposing to each other in the Y axis direction. The swing driving coil 13 is held on the outside faces of the wall parts 116, 117 on both sides in the X axis direction and the wall parts 118, 119 on both sides in the Y axis direction of the camera module holder 102. The swing driving magnet 14 is held on the inside face of each of the side plates 35, 36, 37, 38 that are provided in the cylindrical casing 28 of the fixing member 8. Each swing driving magnet 14, as shown in FIG. 3 and FIG. 4, is divided into two sections in the X axis direction, and the magnetic poles on the interior face side are magnetized so as to be different from each other with reference to a divisional location (magnetized polarized line). The swing driving coil 13 is a coreless coil, and the long edge portions in the +Z direction and −Z direction each are utilized as an effective edge. Here, the cylindrical casing 28 is made of a magnetic material and thus function as a yoke relative to the swing driving magnet 14.

Two sets of the second magnetic driving mechanism 11B for swing, both of which are positioned in the +Y direction and the −Y direction of the movable member 3, are connected by way of wiring so that a magnetic driving force in the same direction at the periphery of the X axis is generated when power is supplied to the swing driving coil 13. In addition, two sets of the first magnetic driving mechanism 11A for swing, both of which are positioned in the +X direction and the −X direction of the movable member 3 are connected by way of wiring so that a magnetic driving force in the same direction at the periphery of the Y axis is generated when power is supplied to the swing driving coil 13. The magnetic driving mechanisms 11 for swing is configured to combine rotation at the periphery of the X axis by the second magnetic driving mechanism 11B for swing and rotation of the Y axis by the first magnetic driving mechanism 11A for swing with each other to thereby rotate the movable member 3 at the periphery of the first axis R1 and the second axis R2. In a case where image stabilization at the periphery of the X axis and image stabilization at the periphery of the Y axis are carried out, this driving mechanism is configured to combine the rotation at the periphery of the first axis R1 and the rotation at the periphery of the second axis R2 with each other.

(Magnetic Driving Mechanism for Rolling)

The magnetic driving mechanism 12 for rolling, as shown in FIG. 2 and FIG. 4, is provided with: two rolling driving coils 15 that are held by the rolling driving coil holding parts 97 that are provided on both sides on which the shaft part 96 is sandwiched therebetween in the Y axis direction, in the holder bottom plate member 82; two rolling driving magnets 16 held by the movable holder of the fixing member 8 and opposing each of the rolling driving coils 15 in the Z axis direction. Each rolling driving magnet 16, as shown in FIG. 3 and FIG. 5, is divided into two sections in the circumferential direction, and magnetic poles on a face opposing to the rolling driving coil 15 are magnetized so as to be different from with reference to a divisional location (magnetized polarized line). Each rolling driving coil 15 is a coreless coil, and a long edge portion extending in a radial direction is utilized as an effective edge.

(Image Stabilization of Optical Unit)

The optical unit 1, as described above, is provided with the magnetic driving mechanism 11 for rolling, configured to carry out image stabilization at the periphery of the X axis and image stabilization at the periphery of the Y axis. Therefore, this optical unit is capable of carrying out image stabilization in the pitching (vertical swing) direction and the yawing (transverse swing) direction. In addition, the optical unit 1 is provided with the magnetic driving mechanism 12 for rolling and thus this optical unit is capable of carrying out image stabilization in the rolling direction. Here, in the optical unit 1, the movable member 3 is provided with a gyroscope, and by way of the gyroscope, the vibration at the periphery of the three axes orthogonal to each other is detected and the magnetic driving mechanism 11 for swing and the magnetic driving mechanism 12 for rolling are driven so as to eliminate the detected vibration.

(Drawing Flexible Printed Circuit Board)

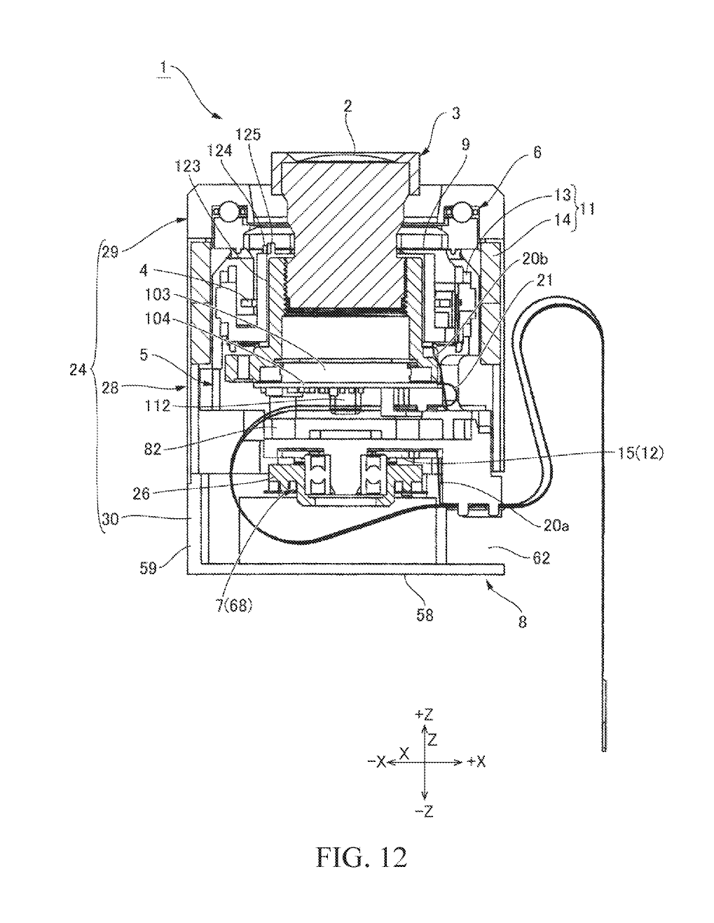

FIG. 12 is a sectional view of the optical unit 1 when taken along a plane passing through the axis L and the flexible printed circuit boards 20a, 20b. As shown in FIG. 12, the flexible printed circuit board 20a is electrically connected to the rolling driving coil 15 that is held by the holder bottom plate member 82. The flexible printed circuit board 20b is electrically connected to the swing driving coil 13 that is fixed to the camera module 101, the swing driving coil being fixed to the respective wall parts 116, 117, 118, 119 of the camera module holder 102. The flexible printed circuit board 21 is electrically connected to the board 104 that is fixed to the camera module 101, the board being held by the rectangular tube part 110 of the camera module 101.

The flexible printed circuit board 20b and the flexible printed circuit board 21 are drawn between the movable member 3 and the holder 5 (holder bottom plate member 82) and then are drawn between the holder 5 (holder bottom plate member 82) and the fixing member (counter-object side casing 30), and are drawn to the outside from the aperture part 62 of the counter-object side casing 30. Here, the flexible printed circuit board 20b and the flexible printed circuit board 21, in a location between the movable member 3 and the holder 5, are drawn in the X axis direction between the first projection part 111 for stopper and the second projection part 112 for stopper, of the first stopper mechanism 17.

(Method for Manufacturing Optical Unit)

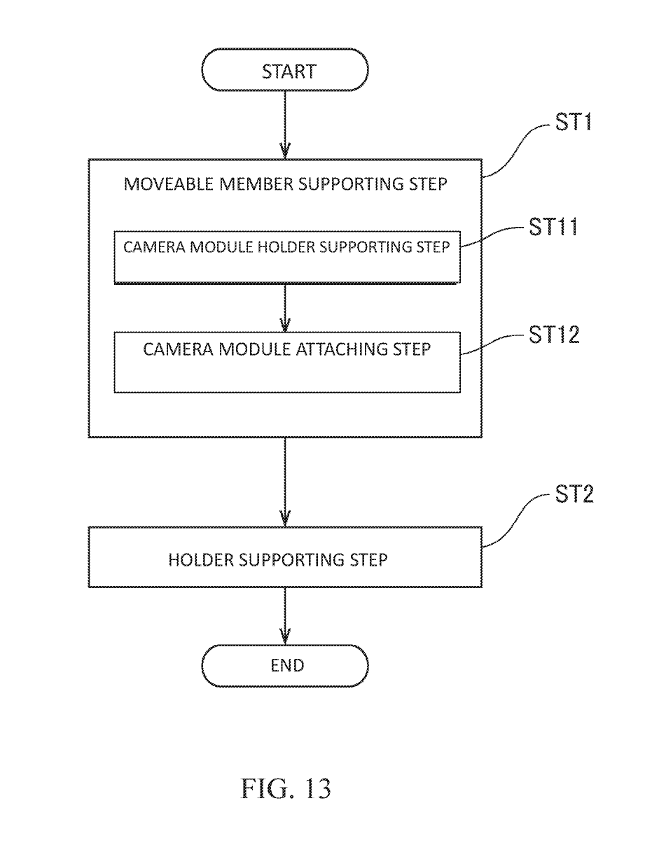

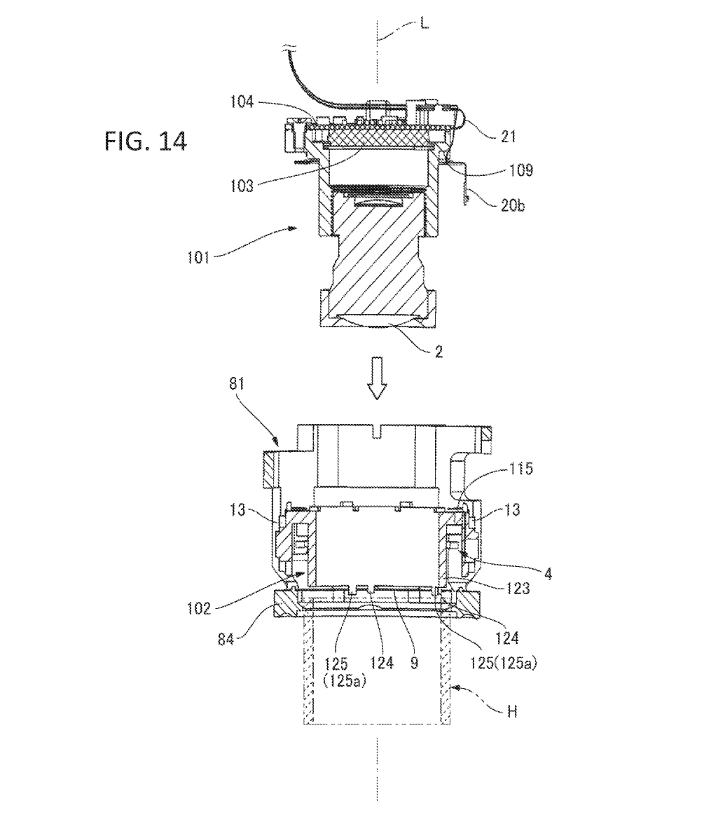

FIG. 13 is a flowchart of a method for manufacturing an optical unit. FIG. 14 is an illustrative view of the steps of attaching a camera module. As shown in FIG. 14, at the time of assembling the optical unit 1, the movable supporting step (step ST1) of causing the holder 5 to swingably support a movable member 3 and the holder supporting step (step ST2) of causing the fixing member 8 to rotatably support the holder 5 (second movable member 10) having supported the movable member 3 by itself are carried out in sequential order.

Here, in the movable supporting step ST1, first, the camera module holder supporting step ST11 of supporting the camera module holder 102 via the swingable supporting mechanism 4 is carried out and then the camera module attaching step ST12 of causing the camera module holder 102 that is supported by the holder 5 to hold the camera module 101 is carried out.

In the camera module holder supporting step ST11, the contact spring 138 is held by a respective one of the first swingable supporting part 131 that is provided in the camera module holder 102 and the second swingable supporting part 132 that is provided in the holder main body member 81 (supporting member), and the contact spring 138 is caused to support the four balls 137 that are fixed to a movable frame 135. In this manner, the camera module holder 102 is swingably supported by the holder main body member 81 via the swingable supporting mechanism 4.

In the camera module attaching step ST12, as shown in FIG. 14, the holder main body member 81 having held the camera module holder 102 by itself is set in a position in which a holder side opposing part 84 of the holder main body member 81 is positioned at a lower end in a vertical direction. Then, from a lower side in the vertical direction, a jig H is caused to abut against four supporting projection parts 125 that are provided in a holding part 123 of the camera module holder 102, and the camera module holder 102 is supported so as to disable swinging from a lower side. Here, the jig H can be employed as an annular jig provided with a flat annular face that is capable of abutting against the four supporting projection parts 125 at the same time, for example. A dimensional outer diameter of the jig H is smaller than a dimensional inner diameter of a holder side opposing part 84 of the holder main body member 81, and can be inserted into the inner circumferential side of the holder side opposing part 84. In addition, the dimensional outer diameter of the jig H is substantially the same as a dimensional inner diameter of a holding part 123 of the camera module holder 102.

Afterwards, as shown in FIG. 13, the camera module 101 in a fixed state, on which flexible printed circuit boards 20b, 21 have been mounted, is inserted into the holding part 123 of the camera module holder 102 from an upper side (counter-object side) in a direction of an axis L, and a plate part 109 of a frame 107 of the camera module 101 is caused to abut against a bottom plate part 115 of the holding part 123. In this manner, the camera module 101 is attached to the holding part 123.

Here, at a time point at which the camera module 101 is inserted into the holding part 123 of the camera module holder 102, the flexible printed circuit board 21 is electrically connected to a board 104, and however, the flexible printed circuit board 20b is not electrically connected to a swing driving coil 13. Therefore, after the camera module 101 has been attached to the camera module holder 102, the flexible printed circuit board 20b and the swing driving coil 13 that is held by the camera module holder 102 are electrically connected to each other. In this manner, the camera module 101 is attached to the holding part 123, and the movable member 3 is configured. Afterwards, the holder bottom plate member 82 is fixed to the holder main body member 81 from an upper side (counter-object side) of the movable member 3 to thereby complete the holder 5. In this manner, the movable member supporting step (step ST1) completes.

Subsequently, in the holder supporting step (step ST2), the fixing member 8 is caused to support the holder 5 having held the movable member 3 by itself, via the first rotation supporting mechanism 6 and the second rotation supporting mechanism 7.

### Functions and Advantageous Effects

In the present embodiment, the step of causing the camera module holder 102 to hold the camera module 101 to thereby complete the movable member 3 is carried out later than the camera module holder supporting step ST11 of causing the holder main body member 81 to support the camera module holder 102 via the swingable supporting mechanism 4. Therefore, in the camera module holder supporting step ST11, adhering of a foreign object such as dust to the optical element 2 can be prevented or restricted. In addition, in the camera module holder supporting step ST11, there is no need to handle the camera module 101 to which the flexible printed circuit board 21 has been connected, so that the camera module holder 102 can be easily supported by the holder main body member 81.

Also, in the camera module attaching step ST12, the camera module holder 102 is supported by the jig H from a lower side (object side) in the direction of the axis L so as to disable swinging, and in this state, the camera module 101 is inserted into, and is held by, the holding part 123 from a lower side. In this manner, the camera module 101 can be easily inserted into the holding part 123 to thus make it easy to carry out the attaching work of causing the camera module holder 102 to hold the camera module 101.

Here, the tip end parts 125a of the four supporting projection parts 125 which the jig H is caused to abut against are obtained as a visual portion configured to enable a visual check without an occurrence of an overlap with respect to the camera module 101, the swingable supporting mechanism 4, and the holder 5 when seen from the object side. Therefore, the jig H can be easily caused to abut against the tip end parts 125a (visual portion) of the four supporting projection parts 125 from the object side.

In addition, portions that cause the jig H to abut are the supporting projection parts 125, each of which projects from the holding part 123 to the object side, so that the location in the direction of the axis L of the tip end faces 125a which the jig abuts against can be easily determined as a predetermined location.

Further, the supporting projection parts 125 that causes the jig H to abut is spaced from each other in a radial direction from the movable member side plate spring fixing part 123b configured to fix the plate spring 9. Therefore, the adhesive agent that is applied to the movable member side plate spring fixing part 123b configured to the plate spring 9 can be prevented from adhering to any of the supporting projection parts 125 that are supported by the jig H. Furthermore, the movable member side plate spring fixing part 123b and the supporting projection parts 125 are spaced from each other in the radial direction to be thereby able to avoid contact or interference between the plate spring 9 that is fixed to the movable member side plate spring fixing part 123b and the jig H. Therefore, when the camera module holder 102 has been supported by the jig H, the plate spring 9 is not deformed.

Still furthermore, in the present embodiment, the tip end faces 125a of the supporting projection parts 125 that causes the jig H to abut are positioned on the object side more significantly than the movable member side plate spring fixing part 123b and are positioned on the object side more significantly than the tip end parts of the plate spring bonding projection parts 124. Therefore, the adhesive agent that is applied to the movable member side plate spring fixing part 123b in order to fix the plate spring 9 can be prevented from adhering to any of the supporting projection parts 125 that are supported by the jig H. Still furthermore, the movable member side plate spring fixing part 123b and the supporting projection parts 125 are spaced from each other in the Z axis direction to be thereby able to avoid contact or interference between the plate spring 9 that is fixed to the movable member side plate spring fixing part 123b and the jig H. Accordingly, when the camera module holder 102 has been supported by the jig H, the plate spring 9 is not deformed.

Yet furthermore, the tip end faces 125a of the supporting projection parts 125 that causes the jig H to abut are positioned on the object side more significantly than the movable member side plate spring fixing part 123b and an area of the tip end face 125a when seen from a side in the direction of the axis L is larger than an area of the tip end of the plate spring bonding projection part 124 when seen from the side in the direction of the axis L. Therefore, the jig H can be easily caused to abut against the supporting projection parts 125 from the side in the direction of the axis L.

Also, in the present embodiment, the four supporting projection parts 125 are provided at equal angular intervals at the periphery of the axis L, so that the weight of the camera module holder 102 can be uniformly received by the jig H that has been caused to abut against the four supporting projection parts 125. Therefore, the camera module holder 102 can be stably supported by the jig H.

In addition, in the present embodiment, the supporting projection parts 125 each are provided in an angular range D that is more proximal to the plate spring bonding projection part 124 than a center C between the plate spring bonding projection part 124 and an angular location B at one circumferential end in the first return portion 143b, in one circumferential side (clockwise direction more significantly than the plate spring bonding projection part 124 at the periphery of the axis L. Here, the first extension portion 143a that is the most proximal to the holding part 123 in the meandering part 143 is likely to interfere with the projection part that is provided in the holding part 123 when the movable member 3 swings and then the plate spring 9 deforms. However, in the clockwise direction of the circumferential direction more significantly than the plate spring bonding projection part 124 and in the angular range D that is more proximal to the plate spring bonding projection part 124 than the center between the plate spring bonding projection part 124 and an end in the clockwise direction in the circumferential direction in the first return portion 143b, when the movable member 3 has swung, a displacement toward the holding part 123 (inner circumferential side) is smaller in comparison with any other portion. Therefore, as long as the supporting projection parts 125 are provided in such an angular range D, even in a case where the movable member 3 swings and the plate spring 9 deforms, interference between the plate spring 9 and the projection parts can be prevented.

### Modification Example

Incidentally, it may be that a projection part is provided in the jig H configured to support the camera module holder 102 in place of providing the supporting projection parts 125 in the holding part 123 of the camera module holder 102, and in the camera module attaching step ST12, a tip end of the projection part of the jig H is caused to abut against an annular portion on the inner circumferential side more significantly than the movable member side plate spring fixing part 123b in the annular end face 123a of the holding part 123 to thereby support the camera module holder 102. In this case as well, the annular portion on the inner circumferential side more significantly than the movable member side plate spring fixing part 123b in the annular end face 123a of the holding part 123, when seen from the object side, is obtained as a visible portion configured to enable a visual check without an occurrence of an overlap with respect to the camera module 101, the swingable supporting mechanism 4, and the holder 5. Therefore, the projection part that is provided in the jig H can be caused to abut against the annular portion on the inner circumferential side more significantly than the movable member side plate spring fixing part 123b in the annular end face 123a.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An optical unit with shake correction function comprising:
a movable member comprising:
a camera module comprising an optical element and an image pickup element that is positioned on an optical axis of the optical element; and
a camera module holder comprising a cylindrical holding part configured to hold the camera module from an outside in a radial direction that is orthogonal to the optical axis;
a swingable supporting mechanism configured to swingably support the movable member between a reference position in which a predetermined axis and an optical axis of the optical element are coincident with each other and a tilt position in which the optical axis tilts relative to the axis; and
a supporting member configured to support the holding part via the swingable supporting mechanism,
wherein when the movable member is set in the reference position, in a case where the movable member, the swingable supporting mechanism, and the supporting member are seen from an object side in a direction of the axis, the holding part comprises a visible portion configured to enable a visual check without an occurrence of an overlap with respect to the camera module, the swingable supporting mechanism, and the supporting member.

2. The optical unit with shake correction function according to claim 1, wherein
the holding part comprises a projection part that projects to the object side, and
the visible portion is a tip end part of the projection part.

3. The optical unit with shake correction function according to claim 2, wherein
the swingable supporting mechanism comprises a plate spring that is overhung between the holding part and the supporting member,
the holding part comprises a movable member side plate spring fixing part to which the plate spring is fixed,
the movable member side plate spring fixing part is positioned on an outer circumferential side of the projection part, and
the movable member side plate spring fixing part and the projection part are spaced from each other in a radial direction.

4. The optical unit with shake correction function according to claim 3, wherein the projection part projects from an end portion on an inner circumferential side of the holding part.

5. The optical unit with shake correction function according to claim 3, wherein the tip end part of the projection part is positioned on the object side more than the movable member side plate spring fixing part in the direction of the axis.

6. The optical unit with shake correction function according to claim 5, wherein
the holding part comprises a plate spring bonding projection part that projects to the object side, on an inner circumferential side of the movable member side plate spring fixing part,
a tip end of the projection part is positioned on the object side more significantly than a tip end of the plate spring bonding projection part, and
an area of a tip end part of the visible portion when seen from a side in a direction of an axis is larger than an area of a tip end part of the plate spring bonding projection part when seen from the side in the direction of the axis.

7. The optical unit with shake correction function according to claim 6, wherein
the plate spring comprises:
a movable member side liking part that is fixed to the movable member side plate spring fixing part;
a supporting member side linking part that is fixed to the supporting member on an outer circumferential side of the movable member side linking part; and
a meandering part positioned between the holding part and he supporting member in a radial direction that is orthogonal to the axis, the meandering part being configured to interconnect the movable member side linking part and the supporting member side linking part,
the meandering part comprises:
a first extension portion extending to one circumferential side on an outer circumferential side of the holding part from a linking portion that is positioned outside in a radial direction of the plate spring bonding projection part in a movable member side linking part;
a first return portion curving from a tip end of the first extension portion to an outer circumferential side;
a second extension portion extending from a tip end of the first extension portion to another circumferential side on an outer circumferential side of the first extension portion and reaching said another circumferential side more significantly than the plate spring bonding projection part; and
a second return portion curving to one circumferential side from a tip end of the second extension portion to an outer circumferential side, and
the projection part, on one circumferential side more than the plate spring bonding projection part, at a periphery of the axis, is provided in an angular range that is more proximal to the plate spring bonding projection part than a center between the plate spring bonding projection part and an end on said circumferential side in the first return portion.

8. The optical unit with shake correction function according to claim 7, wherein
the movable member die linking part is formed in an annular shape,
the plate spring bonding projection part comprises the plate spring bonding projection part in plurality that are provided at equal angular intervals at the periphery of the axis,
the meandering part comprises the meandering part in plurality that are provided at equal angular intervals at the periphery of the axis, the plurality of meandering parts being positioned on an outer circumferential side of each plate spring bonding projection part, and
the projection part comprises the projection part in plurality that are provided at equal angular intervals at the periphery of the axis.

9. The optical unit with shake correction function according to claim 4, wherein the tip end part of the projection part is positioned on the object side more significantly than the movable member side plate spring fixing part in the direction of the axis.

10. The optical unit with shake correction function according to claim 9, wherein
the holding part comprises a plate spring bonding projection part that projects to the object side, on an inner circumferential side of the movable member side plate spring fixing part,
a tip end of the projection part is positioned on the object side more significantly than a tip end of the plate spring bonding projection part, and
an area of a tip end part of the visible portion when seen from a side in a direction of an axis is larger than an area of a tip end part of the plate spring bonding projection part when seen from the side in the direction of the axis.

11. The optical unit with shake correction function according to claim 10, wherein
the plate spring comprises:
a movable member side liking part that is fixed to the movable member side plate spring fixing part;
a supporting member side linking part that is fixed to the supporting member on an outer circumferential side of the movable member side linking part; and
a meandering part positioned between the holding part and the supporting member in a radial direction that is orthogonal to the axis, the meandering part being configured to interconnect the movable member side linking part and the supporting member side linking part,
the meandering part comprises:
a first extension portion extending to one circumferential side on an outer circumferential side of the holding part from a linking portion that is positioned outside in a radial direction of the plate spring bonding projection part in a movable member side linking part;
a first return portion curving from a tip end of the first extension portion to an outer circumferential side;
a second extension portion extending from a tip end of the first extension portion to another circumferential side on an outer circumferential side of the first extension portion and reaching said another circumferential side more than the plate spring bonding projection part; and
a second return portion curving to one circumferential side from a tip end of the second extension portion to an outer circumferential side, and
the projection part is provided in an angular range that is more proximal to the plate spring bonding projection part than a center between the plate spring bonding projection part and an end on said one circumferential side in the first return portion.

12. The optical unit with shake correction function according to claim 11, wherein
the movable member die linking part is formed in an annular shape,
the plate spring bonding projection part comprises the plate spring bonding projection part in plurality that are provided at equal angular intervals at the periphery of the axis,
the meandering part comprises the meandering part in plurality that are provided at equal angular intervals at the periphery of the axis, the plurality of meandering parts being positioned on an outer circumferential side of each plate spring bonding projection part, and
the projection part comprises the projection part in plurality that are provided at equal angular intervals at the periphery of the axis.

13. A method for manufacturing the optical unit comprising:
a movable member comprising:
a camera module having an optical element and an image pickup element that is positioned on an optical axis of the optical element; and
a camera module holder having a cylindrical holding part configured to hold the camera module from an outside in a radial direction that is orthogonal to the optical axis;
a swingable supporting mechanism configured to swingably support the movable member between a reference position in which a predetermined axis and an optical axis of the optical element are coincident with each other and a tilt position in which the optical axis tilts relative to the axis; and
a supporting member configured to support the holding part via the swingable supporting mechanism,
wherein when the movable member is set in the reference position, in a case where the movable member, the swingable supporting mechanism, and the supporting member are seen from an object side in a direction of the axis, the holding part comprises a visible portion configured to enable a visual check without an occurrence of an overlap with respect to the camera module, the swingable supporting mechanism, and the supporting member.
the method comprising:
causing the camera module holder to support the supporting member via the swingable supporting mechanism;
causing a jig to abut against the visible portion in the direction of the axis to thereby swingably support the camera module holder; and
inserting the camera module into the holding part from an opposite side to the jig to thereby hold the camera module by the camera module holder.
